(19) United States
(12) Patent Application Publication
(10) Pub. No.: US 2013/0183197 A1
(43) Pub. Date: Jul. 18, 2013

(54) CHEMILUMINESCENT SYSTEM

(71) Applicant: OMNIGLOW, LLC, West Springfield, MA (US)

(72) Inventor: John Mark Friedson, Longmeadow, MA (US)

(73) Assignee: OMNIGLOW, LLC, West Springfield, MA (US)

(21) Appl. No.: 13/744,001

(22) Filed: Jan. 17, 2013

Related U.S. Application Data
(60) Provisional application No. 61/587,967, filed on Jan. 18, 2012.

(51) Int. Cl. G01N 21/76

(52) U.S. Cl. CPC G01N 21/76
USPC 422/52

(57) ABSTRACT

A chemiluminescent system includes a substrate comprising a solid chemiluminescent oxalate and a solution comprising an oxygen-providing compound. The chemiluminescent system provides improved light-output characteristics.

### BACKGROUND

The present disclosure relates to chemiluminescent systems, and more particularly to chemiluminescent marking systems including a substrate and a marking solution.

Chemiluminescent formulations include chemical substances that convert a chemical energy into cool light through an exothermic reaction. In such a reaction, the energy released from the exothermic reaction is manifested not as heat, but as light. The released energy is absorbed by electrons in certain molecules, and causes the electrons to jump to a higher level (an excited state). As the electrons in the excited state return to the lower ground state, they release energy that can be seen as a photon of light. This process is referred to as chemiluminescence. Chemiluminescense has been used in various glow-in-the dark products such as glow sticks, children's toys, safety devices and the like.

Such glow-in the dark products typically include two chemical components, i.e. an oxalate component and an activator/oxidizing component, which are kept separated until a desired time. The oxalate component generally includes an oxalate ester and a solvent, and the activator component generally includes hydrogen peroxide and a solvent. Further, a fluorescer compound and a catalyst for enhancing luminescence intensity and lifetime control are typically included in one or both component solutions. Commercially available glow products typically utilize a chemiluminescent reaction between hydrogen peroxide and an oxalate ester. This oxidation reaction produces two molecules of carbon dioxide, and releases energy that transfers to fluorescent dye molecules.

US 2008/0128666 discloses a chemiluminescent system comprising a substrate providing an oxidizing component, and a marker solution including an oxalate and a fluorescer. This reference explicitly discloses that the reaction between the oxalate and fluorescer in the marker solution and the oxidizer on the substrate is weak, so a layer of an oxidizer activator is provided adjacent the oxidizer layer on the substrate.

Accordingly, there is a need for an improved chemiluminescent system, which provides improved glow characteristics without the need of such a separate layer of activator on the substrate, thus providing a simpler and more cost effective manufacturing process. These and other advantages of the invention, as well as additional inventive features, will be apparent from the description of the invention provided herein.

### BRIEF SUMMARY

A chemiluminescent system, which includes a substrate comprising a solid reduced hydrolysis oxalate and a solution comprising an oxygen-proving component, is provided according to various embodiments. At least one fluorescer compound is included in the substrate and/or the solution. The chemiluminescent system provides improved light-output characteristics over conventional systems including an oxalate solution, by increasing the available quantity of oxalate in a porous substrate.

In one aspect, a chemiluminescent system is provided. The chemiluminescent system includes a substrate containing a solid reduced hydrolysis oxalate and at least one applicator, which contains an oxidizer solution including an oxygen-providing compound and a solvent. Further, at least one of the substrate and the oxidizer solution includes at least one fluorescer compound. In this system, when the oxidizer solution is applied on the substrate using the applicator, a glow-in-the dark marking is provided.

In an embodiment, the solid reduced hydrolysis oxalate is bis{3,4,6-trichloro-2-[(3-methylbutoxy)carbonyl]phenyl} oxalate (CIPO). The solid reduced hydrolysis oxalate may be embedded in a porous substrate. For example, the substrate is a paper and the solid reduced hydrolysis oxalate is mixed in with pulp during a paper making process. Alternatively, the solid reduced hydrolysis oxalate can be applied or the substrate as a layer.

Preferably, the oxygen-providing compound is hydrogen peroxide. In some embodiments, the oxidizer solution further includes a stabilizer for the oxygen-providing compound, for example, tertiarybutyl alcohol. The solvent is a suitable non-aqueous solvent, for example, triethyl citrate. Further, the oxidizer solution may also include a second solvent to enhance light-output. The second solvent, such as propylene glycol dibenzoate, can also function as a solvent for the solid reduced hydrolysis oxalate. In an embodiment, the oxidizer solution also includes a fluorescer compound.

The chemiluminescent system may include multiple applicators, each including a formulation to provide a selected color. For example, a first applicator can includes a first fluorescer compound, and a second applicator including a second fluorescer compound, in which the first fluorescer compound provides a different color marking than the second fluorescer compound. Examples of the applicator for the oxidizer solution include a marker, pen, paint-brush, spray, roller, or stamp pad.

In a different embodiment, the substrate is pre-printed with at least one fluorescer compound according to desired shapes and sizes. In such an embodiment, the substrate provides the glow-in the dark marking according to the pre-printed shapes and sizes when the oxidizer solution is applied on the substrate.

Other aspects, objectives and advantages will become more apparent from the following detailed description.

### DETAILED DESCRIPTION

While the present disclosure is susceptible of embodiment in various terms, there will hereinafter be described a presently preferred embodiment with the understanding that the present disclosure is to be considered an exemplification and is not intended to limit the disclosure to the specific embodiment illustrated. The words “a” or “an” are to be taken to include both the singular and the plural. Conversely, any reference to plural items shall, where appropriate, include the singular.

A chemiluminescent system comprising an oxidizer solution and a substrate containing a solid oxalate is provided according to an embodiment. The oxalate may be provided as a separate layer on a substrate, or preferably embedded in the substrate. The oxidizer solution includes an oxidizing component, which is also referred to herein as an oxygen-providing compound, such as a stable peroxide, which releases oxygen during its reaction with a chemiluminescent oxalate and a fluorescer. The fluorescer compound may be included in at least one of the substrate and the oxidizer solution.

The oxidizer solution comprises an ester of sufficiently high purity, such as triethyl citrate, in which an oxidizing component, such as hydrogen peroxide is dissolved. The oxidizer solution may also include a catalyst, such as sodium salicylate, and one or more fluorescers. In some embodiments, one or more additional esters, such as propylene glycol dibenzoate, is also included in the oxidizer solution to enhance light output. The additional esters, such as propylene glycol dibenzoate, can also act as a solvent for oxalate when the oxidizer solution comes in contact with the substrate containing the solid oxalate. Thus, in such embodiments, the oxidizing solution provides both a solvent for the oxygen-providing compound and a solvent for the oxalate in one system.

Suitable oxygen-providing compounds include, but are not limited to, common chemical bleaches, such as sodium hypochlorite, chlorine bleach, and oxygen bleach, which contain hydrogen peroxide, and other peroxide liberating compounds, such as calcium peroxide, urea peroxide, perborate, percarbonate, and carbamide peroxide. Preferably, the oxidizer solution includes a peroxide, particularly hydrogen peroxide. In one embodiment, the oxidizer solution is a non-water-based solution, and comprises between about 1.5% wt. to about 25% wt. hydrogen peroxide dissolved in a non-aqueous solvent. Preferable, the oxidizer solution comprises about 2.5% wt. hydrogen peroxide. Further, the oxidizer solution may also contain at least one fluorescer compound and/or a stabilizer.

In an embodiment, the oxygen-providing compound, e.g. hydrogen peroxide, is kept stable and dissolved in a suitable solvent, such as triethyl citrate. The oxidizer may also include an additional stabilizer, such as tertiarybutyl alcohol. Further, the oxidizer solution includes one or more fluorescer compounds, such as 9,10-bis(phenylethynyl)anthracene, 1-chloro-9,10-bis (phenylethynyl)anthracene, and the like.

The oxidizer solution is provided in an applicator, such that when a user applies the oxidizer solution on the substrate using the applicator, the oxidizing component in the solution reacts with the oxalate in the substrate to release energy, which charges the fluorescer to provide a glow-in-the dark marking. Some examples of the applicator for the oxidizer solution include a marker, pen, paint-brush, spray, roller, stamp pad, and other similar solution delivery devices.

The substrate, such as a paper, includes a solid reduced hydrolysis oxalate, such as bis{3,4,6-trichloro-2-[(3-methylbutoxy)carbonyl]phenyl} oxalate (CIPO), which can be incorporated into all or part of the substrate depending on the desired glow pattern and glow duration. In some embodiments, one or more fluorescer compounds are included in the substrate mix depending on the desired colors, shades of colors, and color patterns of chemiluminescent system, as such chemiluminescent characteristics are driven by the amount, type and location of the fluorescer dyes.

The substrate is sufficiently porous or absorbent, such that when the oxidizer solution is applied on the substrate using an applicator, the solution containing the oxygen-providing compound can penetrate through pores and come in contact with the oxalate in the substrate, which starts the reaction to release energy to charge the fluorescer. Thus, a user can write or draw letters, numbers, figures, etc. on the substrate using the applicator, for example, a marker, to provide glow-in-the dark marks in desired shapes and sizes.

Substrates other than paper may also be used as long as it can support a layer of the solid reduced hydrolysis oxalate, or can be intermixed with the oxalate and includes sufficient porosity or absorbency to allow the oxidizer solution to come is contact with the embedded oxalate. Suitable substrate materials include paper, fabric, cotton, sponge, and surfaces of a three-dimensional object, such as a model, figurine, or toy.

In one embodiment, the chemiluminescent system comprises a paper substrate including a solid reduced hydrolysis oxalate, such as CIPO, and multiple applicators, each including an oxygen-providing compound, such as hydrogen peroxide, and a fluorescer. Each of the applicators includes a different fluorescer compound to provide a different color marking when applied on the paper substrate. The fluorescer compound may include a dye matching the glow-in-the dark fluorescer color, such that the color is visible. The oxidizer solutions are also formulated such that the quantity of hydrogen peroxide and other oxygen-providing compounds are scaled according to the amount of the oxalate available on the substrate.

The paper substrate may be prepared in a laboratory by following steps. First cut the paper in pieces, for example, 2 to 3 cm width pieces, and place the paper pieces in a container, such as a stainless steel container. Add clean water in the container to cover the paper pieces and soak overnight. The soaking process can be expedited by heating the contents in an oven for about 4 hours at 100° F. Weigh the soaked paper and add the desired amount of CIPO. For example, for 14% wt. oxalate formulation, weight 15 g of soaked paper and add 2.1 g CIPO. Fill a blender with 750 ml water, and the weighed mixture of the soaked paper and CIPO. Mix the mixture in the blender until the paper is dissolved in the water to avoid clumps of paper. Empty the dilated pulp mixture into a container and repeat the process until a desired amount of the pulp mixture is obtained. If additional support to maintain shape is desired, prepare a metal mesh by spraying it with a non-stick coating, such as Teflon®, to prevent the pulp from sticking. Stir the pulp mixture in the container, and place the metal mesh into the container and spread the pulp on the mesh. Remove the mesh with the pulp, and place it on a paper towel and leave to drain by tilting the mesh slightly. When dried, remove the paper from the mesh. Although, the steps were explained in a laboratory scale, the similar steps can be scaled up for larger quantities to produce the paper substrate in a manufacturing environment.

In a different embodiment, the glow paper system comprises a paper substrate including a solid reduced hydrolysis oxalate. The paper substrate can be prepared by the steps described above with regard to the previous example. The paper substrate is pre-applied with one or more fluorescer compounds according to desired shapes, sizes and colors, for example, via printing or stamping or other known dye application processes. For example, a sign can be pre-printed using multiple fluorescer compounds. The glow paper system further includes an applicator containing an oxidizer solution or an activator. In such a system, the user can apply the oxidizer solution on the pre-printed substrate using the applicator, such as a paint-brush, to provide a professional quality glow-in-the dark sign at a desired time, without actually having to drawing the sign himself.

In one embodiment, a face mask is made of paper containing the solid reduced hydrolysis oxalate. For example, CIPO can be mixed with paper pulp, as described above, which can then be molded into a mask. The mask can be painted with one or more fluorescer compounds in different colors using a paint brash or a marker. Users can paint such a mask in different colors and design, and wear it for different occasions, such as a Halloween party or a costume party.

The chemiluminescent systems including the solid oxalate in the substrate according to various embodiments of the present invention provide improved glow characteristics when compared to conventional systems including oxalate solutions. When the oxalate is provided in a solution, the quantity of the oxalate available for the chemiluminescent reaction is limited when compared to the substrate including the solid oxalate. For example, an oxalate solution including CPPO can only be solvated up to a maximum of about 23% wt. to about 25% wt. of CPPO. Further, the amount of the CPPO absorbed by the substrate is even less, likely less than 8% wt.

For example, a chemiluminescent marking system, which is available in the market from Crayola, LLC., was tested for oxalate solution absorption. The Crayola system included an oxalate solution, an activator solution containing a solvent for an oxygen-providing compound, and a paper substrate including the oxygen-providing compound. A 1″×1″ sample of the paper substrate was prepared, which weighed 0.1690 g. The sample paper substrate was then applied with the oxalate solution and the activator solution until saturation according to the instructions provided. After the solutions were applied the sample substrate weighed 0.2435 g, in which 0.0600 g of the oxalate solution and 0.0145 g of the activator solution were absorbed. As discussed above, oxalate solution can only contain a maximum of about 25% wt. oxalate, for example CPPO. As such, the maximum possible oxalate absorbed by the Crayola's paper substrate is less than about 6% wt. ((0.0600 g×0.25)/0.2435 g=0.06).

However, the substrate containing the solid oxalate is not limited by the solubility of the oxalate in a solvent or the saturation limit of the substrate by the oxalate solution. The paper substrate according to various embodiments can contain up to about 35% wt. of oxalate, preferably about 14% wt. oxalate, which is significantly greater than the oxalate quantity made available by the oxalate solution systems.

Moreover, chemiluminescent characteristics of the systems including an oxalate solution and a substrate including an oxidizing compound are further limited by an oxidizer activator layer, which is required due to its weak reaction. That is, the porosity of the substrate including the oxidizing compound is reduced by the oxidizer activator layer, and thus, limits the contact between the oxalate and the oxidizing compound. However, such a separate activator layer is not necessary for systems including the oxidizer solution and the oxalate substrate. Thus, the chemiluminescent systems including the substrate comprising solid oxalates and the oxidizer solution according to various embodiments of the present invention can provide improved glow characteristics.

Light output of Crayola's system, which included the oxalate solution, the activator solution, and the paper substrate including the oxygen-providing compound, was tested and compared against a chemiluminescent system including a solid oxalate paper substrate and an oxidizing solution according to an embodiment. The solid oxalate paper substrate included 14% wt. of CIPO. The oxidizer solution included hydrogen peroxide in triethyl citrate, propylene glycol dibenzoate, and a catalyst. The test results are shown in table 1.

TABLE 1
Light Output*

| Sample | Temp | KO** | 15 min | 30 min | 1 hr | 2 hr | 3 hr | 4 hr |
|---|---|---|---|---|---|---|---|---|
| Crayola—Yellow | ambient | 0.296 | 1.041 | 0.645 | 0.144 | 0.029 | — | — |
| Crayola—Green | ambient | 0.503 | 1.364 | 0.864 | 0.147 | 0.029 | — | — |
| Sample 1—Yellow | ambient | 4.700 | 5.534 | 3.126 | 1.761 | 0.912 | 0.370 | 0.260 |
| Sample 2—Green | ambient | 5.500 | 7.421 | 3.916 | 2.912 | 1.451 | 0.736 | 0.364 |

*The light output measurements are in lux.
**KO—Kick Off or initial light output at activation.

As shown, present chemiluminescent systems including the solid oxalate paper substrate and the oxidizing solution (Sample 1-yellow and Sample 2-green) exhibit substantially superior glow characteristics, both in intensity and duration, when compared to the Crayola systems.

In the present disclosure, the words “a”or “an” are to be taken to include both the singular and the plural. Conversely, any reference to plural items shall, where appropriate, include the singular. All of the concentrations noted herein as percentage are percent by weight unless otherwise noted.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A chemiluminescent system, comprising:
a substrate including a solid reduced hydrolysis oxalate;
at least one applicator, wherein each of the at least one applicator contains an oxidizer solution including an oxygen-providing compound and a solvent;
wherein at least one of the substrate and the oxidizer solution includes at least one fluorescer compound; and
wherein when the oxidizer solution is applied on the substrate using the applicator, a glow-in-the dark marking is provided.

2. The chemiluminescent system of claim 1, wherein the solid reduced hydrolysis oxalate is bis{3,4,6-trichloro-2-[(3-methylbutoxy)carbonyl]phenyl} oxalate (CIPO).

3. The chemiluminescent system of claims 1 or 2, wherein solid reduced hydrolysis oxalate is embedded in the substrate.

4. The chemiluminescent system of claim 3, wherein the substrate is a paper and the solid reduced hydrolysis oxalate is mixed in with a pulp during a paper making process.

5. The chemiluminescent system of claims 1 or 2, wherein the solid reduced hydrolysis oxalate is applied on the substrate as a layer.

6. The chemiluminescent system of any of claims 1-5, wherein the oxygen-providing compound is hydrogen peroxide.

7. The chemiluminescent system of any of claims 1-6, wherein the oxidizer solution further includes a stabilizer for the oxygen-providing compound.

8. The chemiluminescent system of any of claims 1-7, wherein the stabilizer is tertiarybutyl alcohol.

9. The chemiluminescent system of any of claims 1-8, wherein the solvent is triethyl citrate.

10. The chemiluminescent system of any of claims 1 -9, wherein the oxidizer solution includes a second solvent, which functions as a solvent for the solid reduced hydrolysis oxalate.

11. The chemiluminescent system of any of claims 1-10, wherein the second solvent is propylene glycol dibenzoate.

12. The chemiluminescent system of any of claims 1-11, wherein the oxidizer solution includes a fluorescer compound.

13. The chemiluminescent system of any of claims 1-12, wherein the substrate is a porous substrate.

14. The chemiluminescent system of any of claims 1-13, wherein the at least one applicator includes a first applicator and a second applicator, the first applicator including a first fluorescer compound and the second applicator including a second fluorescer compound, wherein the first fluorescer compound provides a different color marking that the second fluorescer compound.

15. The chemiluminescent system of any of claims 1-11, wherein the substrate is pre-printed with the at least one fluorescer compound according to a desired shape and size.

16. The chemiluminescent system of claim 15, wherein the substrate provides the glow-in the dark marking according to the pre-printed shape and size when the oxidizer solution is applied on the substrate.

17. The chemiluminescent system of any of claims 1-16, wherein the at least one applicator is a marker, pen, paint-brush, spray, roller, or stamp pad.
